(19) United States
(12) Patent Application Publication
(10) Pub. No.: US 2001/0012185 A1
(43) Pub. Date: Aug. 9, 2001

(54) A MAGNETORESISTANCE EFFECT ELEMENT AND A MAGNETIC HEAD EMPLOYING A MAGNETORESISTANCE EFFECT ELEMENT

(76) Inventors: SHOJI TERADA, MIYAGI (JP); AKIRA KOUCHIYAMA, KANAGAWA (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 08/824,717

(22) Filed: Mar. 26, 1997

(30) Foreign Application Priority Data
Mar. 29, 1996 (JP) P08 077990

(51) Int. Cl. G11B 5/39

(52) U.S. Cl. 360/324

(57) ABSTRACT

A magnetoresistance effect device for generating larger magnetoresistance effect in stability and a magnetoresistance effect type magnetic head employing this magnetoresistance effect device. The magnetoresistance effect device 1 has plural antiferromagnetically coupled magnetic layers layered together with non-magnetic layers in-between. The number of magnetic layers is two to eight. The magnetoresistance effect type magnetic head 20 detects a signal magnetic field from a recording medium by the magnetoresistance effect device 1 having plural antiferromagnetically coupled magnetic layers layered together with the non-magnetic layer in-between, with the number of the magnetic layers of the magnetoresistance effect device 1 being 2 to 8. The magnetoresistance effect device 1 and the magnetoresistance effect type magnetic head 20, thus constructed, exhibit a magnetoresistance effect when fed with the sense current without destructing the antiferromagnetic coupling.

### BACKGROUND OF THE INVENTION

This invention relates to a magnetoresistance effect device and a magnetoresistance effect type magnetic head employing this device.

### DESCRIPTION OF THE RELATED ART

A magnetoresistance effect type magnetic head (MR head) employing a magnetoresistance effect device (MR device) is generally used for a recording medium of a recording/reproducing apparatus, such as a hard disc, for detecting a signal magnetic field recorded on the magnetic recording medium. In the magnetic recording medium, the recent tendency is towards increasing the capacity for recording so-called multimedia data. For realizing this increased capacity of the magnetic recording medium, attempts are being made towards increasing its recording density.

With the increased recoding density of the recording medium, such as a hard disc, it is demanded of the MR head to have improved playback sensitivity. As a MR head whose playback sensitivity is expected to be improved further, development of a giant magnetoresistance effect device (GMR device) is underway. This GMR head has a feature that the magnetoresistance effect is changed more significantly than the MR device for a weak magnetic field from the magnetic recording medium and hence may be used with advantage for reproducing a magnetic recording medium recorded with high recording density.

This GMR device has its resistance value changed responsive to the external magnetic field and, on being fed with a pre-set sense current, detects changes in resistance due to the external magnetic field as changes in voltage. Among known GMR devices, there are a GMR device of a spin-bulb structure and a GMR device of a coupled multi-layered film structure.

The GMR device of the spin-bulb structure is made up of a ferromagnetic layer (free layer), a non-magnetic layer layered on this free layer, another ferromagnetic layer (pin layer) layered on the non-magnetic layer, and an antiferromagnetic layer layered on this pin layer. The direction of magnetization of this pin layer is prescribed in a pre-set direction by the antiferromagnetic layer, while the direction of magnetization of the free layer is set so as not to be prescribed in a particular direction. That is, with the GMR device of the spin bulb structure, the pin layer has a large coercivity, while the free layer has a lower coercivity.

The GMR device of the spin bulb structure has the least resistance value when the direction of magnetization of the free layer is the same as that of the pin layer, while having the maximum resistance value when the direction of magnetization of the free layer is opposite to that of the pin layer. If, when the sense current is supplied to this GMR device of the spin bulb structure, the direction of magnetization of the free layer is opposite to that of the pin layer, the electrons migrated between the free layer and the pin layer undergo significant scattering in a region in the vicinity of the interface between the free layer and the non-magnetic layer and in a region in the vicinity of the interface between the pin layer and the non-magnetic layer, so that the device exhibits maximum resistance in these regions. On the other hand, if the direction of magnetization of the free layer is the same as that of the pin layer, the electrons migrated between the free layer and the pin layer are not scattered in the region in the vicinity of the interface between the free layer and the non-magnetic layer or in the region in the vicinity of the interface between the pin layer and the non-magnetic layer. The device then exhibits minimum resistance in these regions.

However, the above-described GMR device of the spin bulb structure has a drawback that, since it has only two interfaces causing electron scattering, the difference between the maximum resistance and the minimum resistance (resistance change) is only small. As a GMR device possibly free from this drawback, a GMR device of the coupled type multi-layer film structure is attracting general attention.

A GMR device of the coupled type multi-layer film structure 100 is of a multi-layered film structure having magnetic layers 101 arranged in alternation with non-magnetic layers 102. With the GMR device of the coupled type multi-layer film structure 100, two neighboring magnetic layers 101 on both sides of the non-magnetic layer 102 are antiferromagnetically coupled to each other, whereby the directions of the neighboring magnetic layers 101 become opposite to each other.

In the above-described GMR device of the coupled type multi-layer film structure 100, if there is an external magnetic field, the above-mentioned directions of magnetization are varied with the external magnetic field. The GMR device of the coupled type multi-layer film structure 100 is decreased in this manner in resistance value. The GMR device, fed with the sense current of a pre-set current value, detects this resistance value as voltage.

With the GMR device of the coupled type multi-layer film structure 100, since a large number of magnetic layers 101 are layered with the non-magnetic layers 102 in-between, there exist a large number of interfaces scattering the electrons migrated within the inside of the device. Thus the GMR device of the coupled type multi-layer film structure 100 has a feature that it undergoes resistance changes larger than those of the above-described GMR device of the bulb structure.

Similarly to the above-described GMR device of the spin bulb stricture, the GMR device of the coupled type multi-layer film structure 100 undergoes changes in the resistance value when the directions of magnetization of the neighboring magnetic layers 101 are changed relative to the external magnetic field when the device is fed with the sense current. The GMR device of the coupled type multi-layer film structure 100 detects changes in the resistance value by being fed with the pre-set current and by detecting changes in voltage of the sense current.

However, if the sense current is supplied to the GMR device of the coupled type multi-layer film structure 100, magnetic fields are generated inside and outside of the device 100 in the clockwise direction in FIG. 2 by the so-called right-hand rule. The result is that, with the GMR device of the coupled type multi-layer film structure 100, the antiferromagnetic coupling between the magnetic layers 101 is destroyed, such that the directions of magnetization of two neighboring magnetic layers 101 are directed in the same direction. The GMR device of the coupled type multi-layer film structure 100 thus has a drawback that the resistance value in this state becomes small and cannot display the magnetoresistance effect such that no changes in resistance are produced with respect to the external magnetic field.

In addition, in the conventional GMR device, sufficient researches have not been conducted on the magnetic field produced by the sense current, such that it is difficult to control the magnetic field produced by the sense current. Thus, the conventional GMR device 100 has a drawback that difficulties are met in producing the magnetoresistance effect in stability.

### SUMMARY OF THE INVENTION

It is therefore an object of the present invention to overcome the defect in the prior art and to provide a magnetoresistance effect device producing large magnetoresistance effect in stability and a magnetoresistance effect type magnetic head employing this magnetoresistance effect device.

In one aspect, the present invention provides a magnetoresistance effect device in which a plurality of antiferromagnetically coupled magnetic layers are layered together with a non-magnetic layer in-between. The number of the magnetic layers is two to eight.

Preferably, the number of the magnetic layers of the magnetoresistance effect device is even.

With the magnetoresistance effect device, if the current density of the sense current supplied at the time of detecting the changes in resistance is Js, the film thickness is T, and the coupling magnetic field of antiferromagnetic coupling between the magnetic layers is H, preferably the relation shown by the equation (1):

H>Js T/2 (1)

holds.

In another aspect, the present invention provides a magnetoresistance effect type magnetic head for detecting the signal magnetic field from a recording medium by a magnetoresistance effect device in which a plurality of antiferromagnetically coupled magnetic layers are layered together with a non-magnetic layer in-between. The number of the magnetic layers of the magnetoresistance effect device is preferably two to eight.

Preferably, the number of the magnetic layers of this magnetoresistance effect type magnetic head is even.

With the magnetoresistance effect type magnetic head, if the current density of the sense current supplied at the time of detecting changes in resistance of the magnetoresistance effect device is Js, the film thickness of the magnetoresistance effect device is T and the coupling magnetic field of the antiferromagnetic coupling between the magnetic layers of the magnetoresistance effect device is H, preferably the relation shown by the equation (2):

H>Js T/2 (2)

holds.

In the above-described magnetoresistance effect device and the magnetoresistance effect type magnetic head employing the magnetoresistance effect device, the maximum magnetic field is generated for the uppermost layer and the lowermost layer of the magnetoresistance effect device. This maximum magnetic field (Hs) is approximately represented by the following equation (5):

Hs˜Is/(2 W) (3)

where W and Is denote the width of the magnetoresistance effect device and the intensity of the sense current, respectively.

On the other hand, the current density Js of the sense current supplied to the magnetoresistance effect device is given by the following equation (4):

Js=Is/(W T) (4)

where T, W and Is denote the thickness of the magnetoresistance effect device, width of the magnetoresistance effect device and the intensity of the sense current, respectively.

From these equations (3) and (4), the maximum magnetic field Hs is given by the following equation (5):

Hs˜Js T/2 (5)

Therefore, in the magnetoresistance effect device of the present invention, the magnetic field generated by the sense current may be reduced by reducing the film thickness of the magnetoresistance effect device under a pre-set condition of the current density of the sense current. Also, with the magnetoresistance effect device, there exist optimum values of the thickness of the non-magnetic layer of the non-magnetic layer required for coupling and the thickness of the magnetic layer required for increasing the magnetoresistance effect. That is, optimizing the film thicknesses is equivalent to reducing the number of layers.

However, if, for reducing the film thickness, the number of the magnetic layers of the magnetoresistance effect device is reduced to less than two, the magnetoresistance effect is lost. Therefore, a sufficient magnetoresistance effect is accrued if the number of layers of the magnetic layers of the magnetoresistance effect device is not less than two.

Conversely, if the number of the magnetic layers is increased to more than eight for improving the magnetoresistance effect, the magnetic field generated by the sense current is increased. Thus, with the magnetoresistance effect device of the present invention, the magnetoresistance effect can be displayed in stability by setting the number of the magnetic layers to not more than eight.

That is, with the magnetoresistance effect device and the magnetoresistance effect type magnetic head according to the present invention, the condition for generating the large magnetoresistance effect in stability can be optimized by setting the number of the magnetic layers to two to eight.

With the magnetoresistance effect device and the magnetoresistance effect type magnetic head according to the present invention, as described above, the antiferromagnetic coupling formed between the magnetic layers is not destroyed by the magnetic field generated by the sense current. That is, the larger magnetoresistance effect can be obtained in stability by controlling the relation between the magnetic field generated by the sense current and the number of the magnetic layers.

### BRIEF DESCRIPTION OF THE DRAWINGS

FIG. 1 is a schematic cross-sectional view showing the direction of magnetization of a conventional magnetoresistance effect device.

FIG. 2 is a schematic cross-sectional view showing the direction of magnetization of the conventional magnetoresistance effect device fed with the sense current.

FIG. 3 is a schematic perspective view of a magnetoresistance effect device according to the present invention.

FIG. 4 is a circuit diagram of a voltage detection circuit detecting magnetoresistance effect characteristics of the magnetoresistance effect device shown in FIG. 3.

FIG. 5 is a graph showing the relation between the number of layers of the magnetic layers of the magnetoresistance effect characteristics and changes in resistance value of the magnetoresistance effect device.

FIG. 6 is a schematic cross-sectional view of a magnetoresistance effect device according to the present invention.

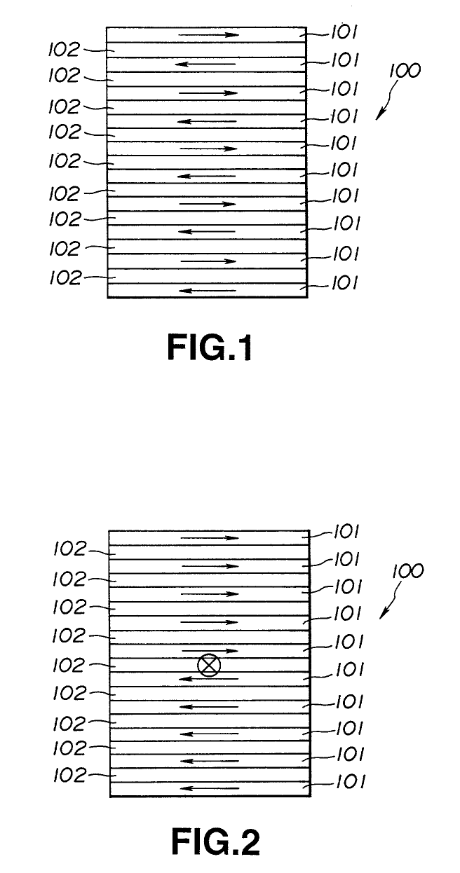

### DESCRIPTION OF THE PREFERRED EMBODIMENTS

Referring to the drawings, a preferred embodiment of a magnetoresistance effect device of the present invention will be explained in detail.

The magnetoresistance effect device of the present embodiment is a giant magnetoresistance effect device (GMR device) exhibiting a giant magnetoresistance effect.

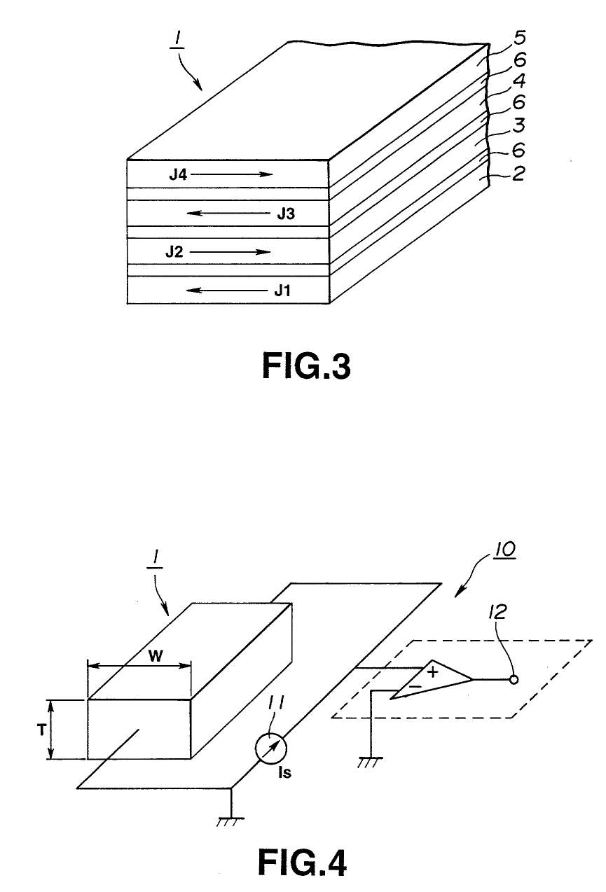

Referring to FIG. 3, a GMR device 1 is made up of a first magnetic layer 2, a second magnetic layer 3, a third magnetic layer 4, a fourth magnetic layer 5 and a non-magnetic layer 6. With the GMR device 1, the second magnetic layer 3 is layered on the first magnetic layer 2 via a non-magnetic layer 6, while the third magnetic layer 4 is layered on the second magnetic layer 3 via another non-magnetic layer 6 and the fourth magnetic layer 5 is layered on the third magnetic layer 4 via a further nonmagnetic layer 6.

Each of the first magnetic layer 2 to the fourth magnetic layer 5 is a soft magnetic film of Ni—Fe or layered films inclusive of an Ni—Fe film, and antiferromagnetic coupling is formed between neighboring ones of the magnetic layers. Therefore, the direction of magnetization of the first magnetic layer 2, that is the direction indicated by arrow J1 in FIG. 3, is substantially opposite to the direction of magnetization of the second magnetic layer 3, that is to the direction indicated by arrow J2 in FIG. 3. The direction of magnetization of the third magnetic layer 4, that is the direction indicated by arrow J3 in FIG. 3, is substantially opposite to the direction of magnetization of the second magnetic layer 3, that is to the direction indicated by arrow J2 in FIG. 3. On the other hand, the direction of magnetization of the fourth magnetic layer 5, that is the direction indicated by arrow J4 in FIG. 3, is substantially opposite to the direction of magnetization of the third magnetic layer 4, that is to the direction indicated by arrow J4 in FIG. 3. The magnetic layers from the first magnetic layer 2 to the fourth magnetic layer 5 are each of a film thickness of approximately 2 nm.

The non-magnetic layers 6 are each formed of an electrically conductive non-magnetic material, such as Cu, Cr, Ag, Au or Al. These non-magnetic layers 6 are interposed between the first magnetic layer 2 and the second magnetic layer 3, between the second magnetic layer 3 and the third magnetic layer 4 and between the third magnetic layer 4 and the fourth magnetic layer 5 for providing the above-mentioned antiferromagnetic coupling. The non-magnetic layer 6 is set to a film thickness of, for example, approximately 2 nm.

With the above-described GMR device 1, the direction of magnetization of each magnetic layer is changed in the presence of an external magnetic field.

If the directions of magnetization of neighboring magnetic layers of the GMR device 1 are opposite to each other, and if the sense current is supplied to the device, the maximum electron scattering occurs in the neighborhood of the interface between the magnetic layers and the non-magnetic layer. This causes the GMR device 1 to exhibit the maximum resistance value.

On the other hand, if the direction of magnetization of each magnetic layer is changed by the external magnetic field, electron scattering is decreased in the vicinity of the interface between the magnetic layers and the non-magnetic layer. At this time, the resistance value of the GMR device 1 is decreased to a lower value than if the directions of magnetization of the neighboring magnetic layers are directly opposite to each other.

When the above-described GMR device 1 is used in a voltage detection circuit 10 shown in FIG. 4 for detecting the external magnetic field, the sense current of a pre-set value is supplied to the GMR device 1. By the sense current being supplied to the GMR device, the voltage detection circuit 10 detects changes in resistance as changes in voltage.

By the sense current Is being supplied from a constant current source 11 supplying a pre-set current to the GMR device 1, a voltage detection portion 12 detects the resistance value of the GMR device 1 as a voltage.

By the sense current being supplied to the inside of the GMR device 1, a magnetic field is generated within the GMR device 1 in accordance with the so-called right-hand rule. However, since the GMR device 1 has a four-layered structure made up of the first to fourth magnetic layers 2 to 5 with the interposition of the non-magnetic layers 6, there is only little risk of the magnetic field generated by this sense current destructing the antiferromagnetic coupling formed between the neighboring magnetic layers.

The GMR device 1 of the above-described embodiment of the present invention is made up of the first magnetic layer 2 to the fourth magnetic layers 5, as described above. However, the present invention s not limited to this illustrative structure of the magnetoresistance effect device. That is, it suffices if the magnetoresistance effect device of the present invention has two to eight magnetic layers.

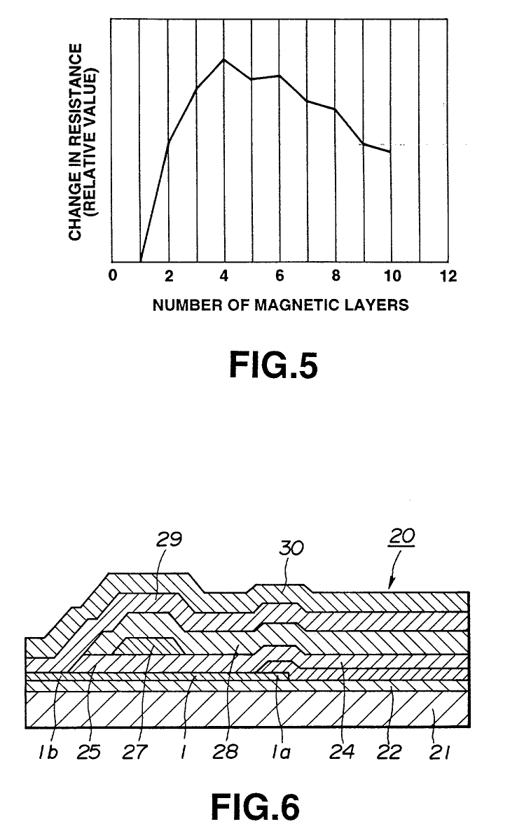

FIG. 5 shows the manner of changes in resistance value of the magnetoresistance effect device for various numbers of the magnetic layers. The magnetoresistance effect device showed significant changes in resistance value for the number of the magnetic layers of from two to eight, as shown in FIG. 5.

This is ascribable to the fact that, if the number of the magnetic layers is not more than two, the magnetoresistance effect of the magnetoresistance effect device is diminished owing to scarcity of the interface between the magnetic layers and the non-magnetic layers and hence to the diminished magnetoresistance effect of the magnetoresistance effect device. On the other hand, if the number of the magnetic layers of the magnetoresistance effect device is not less than eight, the magnetic field generated is increased by the sense current supplied so that the magnetic field by the antiferromagnetic coupling is destroyed to reduce changes in the resistance value.

It is seen from FIG. 5 that the magnetoresistance effect device shows changes in the resistance value that are larger in case the number of the magnetic layers is even than in case the number of the magnetic layers is odd. This is ascribable to the fact that, if the number of the magnetic layers is even, the magnetic field generated when the sense current is supplied operates for stabilizing the direction of magnetization of the uppermost and lowermost magnetic layers. Conversely, if the number of the magnetic layers is odd, the magnetic field generated when the sense current is supplied operates to render the direction of magnetization of the uppermost magnetic layer or the lowermost magnetic layer unstable thus reducing the amount of change of resistance value.

If the coupling magnetic field of the antiferromagnetic coupling between the magnetic layers is H and the maximum magnetic field generated when the sense current is supplied is Hs, it is desirable that the relation H>Hs be maintained in the magnetoresistance effect device of the present invention.

If the film thickness of the magnetoresistance effect device is T, and the current density of the sense current supplied to the magnetoresistance effect device is Js, Hs is approximately given by Hs˜Js T/2. Therefore, the magnetoresistance effect device according to the present invention preferably has the relation H>Js T/2.

Next, a magnetoresistance effect type magnetic head (GMR head) 20 is hereinafter explained.

Referring to FIG. 6, a GMR head 20 includes a lower shield layer 21, a lower gap layer 22 formed on the lower shield layer 21 and a GMR device 1 formed on the lower shield layer 21. The GMR head 20 also includes a rear end electrode 24 formed for partially overlapping with a rear end 1a of the GMR device 1 and an insulating layer 25 formed on the GMR device 1 and the rear end electrode 24. The GMR head 20 also includes an electrically conductive layer 27 for the bias current formed on the insulating layer 25 for overlying the GMR device 1 and another insulating layer 28a formed overlying the electrically conductive layer 27. The GMR head 20 further includes an upper gap layer 29 formed for being connected to a distal end 1b of the GMR device 1 and an upper shield layer 30 forming an uppermost surface.

In the above-described GMR head 20, the lower shield layer 21 and the upper shield layer 30 are formed of a magnetic material, while the lower gap layer 22 is formed of an electrically non-conductive non-magnetic material. The upper gap layer 29 is formed of an electrically conductive non-magnetic material, while the rear end electrode 24 is formed of an electrically conductive magnetic material.

The lower shied layer 21, upper shield layer 30, lower gap layer 22 and the upper gap layer 29 operate for prohibiting entrance into the GMR device 1 of the portion of the magnetic field from the magnetic recoding medium other than that of an object to be reproduced. That is, since the lower shield layer 21 and the upper shield layer 30 are arranged on the lower and upper sides of the GMR device 1 via the lower gap layer 22 and the upper gap layer 29, respectively, the portion of the magnetic field from the magnetic recording medium other than that from the object to be reproduced is conducted to the lower shied layer 21 and to the upper shield layer 30, while only the magnetic field of the object to be reproduced is introduced into the GMR device 1.

On the other hand, the rear end electrode 24 and the upper gap layer 29 operate as an electrode for supplying the sense current to the GMR device 1. That is, the GMR device 1 is electrically connected at the rear end 1a to the rear end electrode 24, while being electrically connected at the distal end 1b to the upper magnetic layer 29. It is via these layers that the sense current is supplied to the GMR device 1 when detecting the signal magnetic field from the magnetic recording medium.

The conductor layer for the bias current 27, formed on the insulating layer 25 for overlying the GMR device 1, is used for impressing a bias magnetic field across the GMR device 1. That is, when detecting the signal magnetic field from the magnetic recording medium, the current is caused to flow in this conductor layer for the bias current 27 whereby the bias magnetic field is impressed for realizing electromagnetic characteristics close to those of the linear operation.

In the above-described GMR head 20, the GMR device 1 has a four-layered structure comprised of the first to fourth magnetic layers 2 to 5, such that, if the sense current is supplied thereto as described above, the antiferromagnetic coupling realized between these magnetic layers is preserved. Therefore, by supplying the sense current to the GMR head 20, a high playback output may be maintained without lowering the magnetoresistance effect characteristics of the GMR device.

The magnetoresistance effect type magnetic head according to the present invention is not limited to the above-described GMR head 20. Specifically, it suffices if the magnetoresistance effect device of the magnetoresistance effect type magnetic head according to the present invention has two to eight magnetic layers.

If the magnetoresistance effect device has not more than two magnetic layers, the magnetoresistance effect of the magnetoresistance effect type magnetic head is lost. Conversely, if the magnetoresistance effect device has more than eight magnetic layers, the magnetic field generated by the sense current is increased to destruct the antiferromagnetic coupling between the magnetic layers to diminish changes in the resistance value.

With the present magnetoresistance effect type magnetic head, in which the number of layers of the magnetoresistance effect device is two to eight, there is no risk of destruction of the antiferromagnetic coupling between the magnetic layers of the magnetoresistance effect device thus assuring a high playback output.

Moreover, in the magnetoresistance effect type magnetic head according to the present invention, if the coupling magnetic field of antiferromagnetic coupling formed between the magnetic layers of the magnetoresistance effect device is H and the magnetic field generated when the sense current is supplied is Hs, it is desirable that the relation H>Has holds. If the film thickness of the magnetoresistance effect device is T and the current density of the sense current supplied to the magnetoresistance effect device is Js, Hs is approximately represented as Hs˜Js T/2. Therefore, with the magnetoresistance effect type magnetic head according to the present invention, it is desirable that the magnetoresistance effect device has the relation of Hs>Js T/2.

With the present magnetoresistance effect type magnetic head, the magnetic field generated when the sense current is supplied can be weakened by diminishing the film thickness T of the magnetoresistance effect device. Also, in the magnetoresistance effect device, there exist optimum values of the thickness of the non-magnetic layer required for coupling and the thickness of the magnetic layer required for increased magnetoresistance effect. That is, reducing the film thickness T is tantamount to decreasing the number of the magnetic layers and the non-magnetic layers layered together. This allows to maintain a high playback output of the magnetoresistance effect type magnetic head without destroying the coupling magnetic field of the antiferromagnetic coupling formed between the magnetic layers of the magnetoresistance effect device.

What is claimed is:

1. A magnetoresistance effect device in which a plurality of antiferromagnetically coupled magnetic layers are layered together with a non-magnetic layer in-between, wherein the improvement resides in that
the number of said magnetic layers is two to eight.

2. The magnetoresistance effect device as claimed in claim 1 wherein the number of said magnetic layers is even.

3. The magnetoresistance effect device as claimed in claim 1 wherein the number of said magnetic layers is four.

4. The magnetoresistance effect device as claimed in claim 1 wherein, if the current density of the sense current supplied at the time of detecting the changes in resistance is Js, the film thickness is T, and the coupling magnetic field of antiferromagnetic coupling between the magnetic layers is H, the relation shown by the equation (1);
H>Js T/2 (1)
holds.

5. A magnetoresistance effect type magnetic head for detecting the signal magnetic field from a recording medium by a magnetoresistance effect device in which a plurality of antiferromagnetically coupled magnetic layers are layered together with a non-magnetic layer in-between, wherein the improvement resides in that
the number of said magnetic layers of said magnetoresistance effect device is two to eight.

6. The magnetoresistance effect type magnetic head as claimed in claim 5 wherein the number of said magnetic layers is even.

7. The magnetoresistance effect type magnetic head as claimed in claim 5 wherein the number of said magnetic layers is four.

8. The magnetoresistance effect type magnetic head as claimed in claim 5 wherein, if the current density of the sense current supplied at the time of detecting changes in resistance of the magnetoresistance effect device is Js, the film thickness of the magnetoresistance effect device is T and the coupling magnetic field of the antiferromagnetic coupling between the magnetic layers of the magnetoresistance effect device is H, the relation shown by the equation (2):
H>Js T/2 (2)
holds.
